(19) United States
(12) Patent Application Publication
(10) Pub. No.: US 2014/0209353 A1
(43) Pub. Date: Jul. 31, 2014

(54) SPIRAL CABLE STRAIN RELIEF DEVICE

(71) Applicant: Aktiebolaget SKF, Goteborg (SE)

(72) Inventors: Jan Lietz, Hesingue (FR); Hans Peter Panzer, Lorrach (DE); Martin Voegelin, Holstein (CH)

(73) Assignee: Aktiebolaget SKF, Goteborg (SE)

(21) Appl. No.: 14/043,487

(22) Filed: Oct. 1, 2013

(30) Foreign Application Priority Data
Oct. 1, 2012 (DE) 102012217941.0

(51) Int. Cl. H02G 15/007

(52) U.S. Cl. CPC H02G 15/007
USPC 174/135

(57) ABSTRACT

A cable strain relief holder (1) for a spirally extending cable (2) is disclosed. In order to be able to fix a cable in a simple manner for the purpose of strain relief, the holder comprises a pillar element (3) which extends in an axial direction (a) and has an outer circumferential surface (4), and at least two retaining elements (5, 6), which are disposed extending radially (r) on the outer circumferential surface (4), wherein the at least two retaining elements (5, 6) are disposed at different axial positions and at different circumferential positions of the pillar element (3).

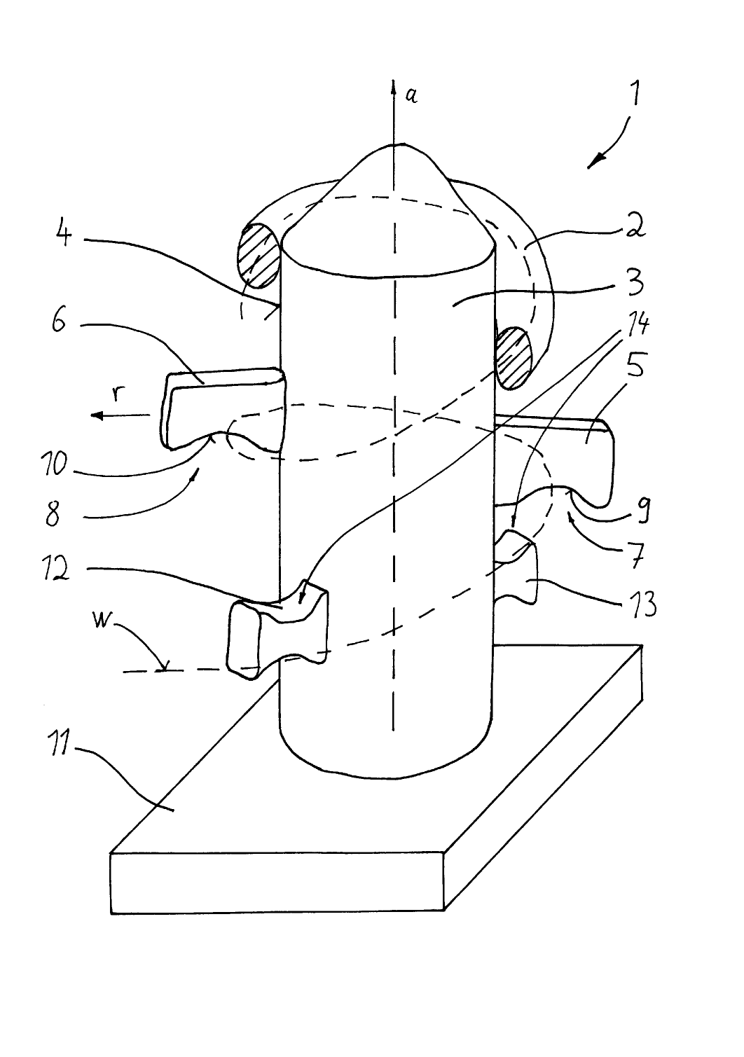

### CROSS-REFERENCE

This application claims priority to German patent application no. 10 2012 217 941.0 filed on Oct. 1, 2012, the contents of which are incorporated herein by reference.

### TECHNICAL FIELD

The present invention relates in general to a cable strain relief holder for a spirally extending cable.

### RELATED ART

In the present case, “cable” is understood to mean, in particular, electrical cables which extend spirally (often referred to as “spiral cable”), so that they allow themselves to be able to be pulled to a considerable extent along the longitudinal direction (e.g. the cable of a telephone handset). However, other types of cables or lines are also encompassed by the present idea, such as for example air hoses, which are often also formed spiral-shaped in order to equip them with a large stretching capacity.

It is known to fix said cables, for example, on a housing using a cable strain relief holder, so that the cable is secured at an axial position and protected from damage. Holders of this type are often formed as a band-shaped element, the end sides of which are fixed to a housing using screws (cable clamps), whereby the cable is clamped and thus fixed. With such a holder the cable can be pulled on without running the risk that it will detach from the housing.

Cable strain relief holders of the above-mentioned type are known for example from U.S. 2010/0233917 A1, from U.S. 2008/0288014 A1, and from U.S. Pat. No. 5,240,092 A.

### SUMMARY

A cable strain relief holder is disclosed which for example manages with as few components as possible and makes complex assembly measures unnecessary. A spirally extending cable shall be able to be immobilized on the holder reliably and simply without a tool. Nevertheless, it shall be ensured that the cable is reliably immobilized at one of its axial positions relative to the holder. Furthermore it is desired that the risk of damage to the cable is minimized.

The holder preferably comprises a pillar element, which extends in an axial direction and has an outer circumferential surface, and furthermore at least two retaining elements, which are disposed extending radially on the outer circumferential surface, wherein the at least two retaining elements are disposed at different axial positions and at different circumferential positions of the pillar element.

The retaining elements are preferably formed pin- or rod-shaped and extend perpendicular to the axial direction, away radially from the pillar element.

The retaining elements can have an underside, which is formed for laying-on of the cable to be held. For this purpose the underside of the retaining element can have a recess congruent with the outer shape of the cable, in particular a circular-arc-segment-shaped shape.

The retaining elements can be disposed on the pillar element such that they follow an imaginary spiral-shaped line.

A lower end of the pillar element can furthermore be connected to a retaining plate.

At least one threading aid, which is formed pin- or rod-shaped, can be disposed below the retaining elements, which threading aid extents perpendicular to the axial direction, away radially from the pillar element.

The pillar element and the retaining elements and optionally the threading aid can be formed one-piece. Alternatively, however, it is also possible that the retaining elements, and optionally the threading aid, are manufactured as separate parts, which are affixed to the pillar element.

The cable strain relief holder is preferably comprised of plastic.

The spirally extending cable can thus be wound around the proposed holder and fixed using the retaining elements. The strain relief of the cable is thus ensured. No further parts are needed to immobilize the cable in this respect at a point and relieve the cable from axial strain.

The laying-on of the cable on the holder can occur very quickly, so that the assembly expense is correspondingly low.

The attaching of the cable strain relief holder to a plastic housing is possible in a simple manner, or directly during the manufacturing of the housing the holder can be integrated therewith. Advantageously, no further parts are necessary for the holder, as mentioned above. In particular, there are no parts to be screwed on. Also no metallic parts are required, which can possibly damage the cable.

The attaching of the cable to the holder can be effected by hand without any tool. This process can also be carried out very quickly, so that the attaching of the cable is correspondingly inexpensive.

It is possible to select any starting position for the immobilization of the cable on the holder.

### BRIEF DESCRIPTION OF THE DRAWINGS

The sole Figure shows in perspective view a cable strain relief holder, wherein the course of a spirally extending cable (“spiral cable”) is indicated.

### DETAILED DESCRIPTION OF THE INVENTION

In the Figure, a cable strain relief holder 1 is shown. It immobilizes a cable 2, of which only a short section is indicated. The cable 2 is formed as a spirally extending cable (“spiral cable”), so that it has the property of being able to be pulled along the axial extension with high stretching property.

The cable of a telephone handset is mentioned as an example. Cables of this type are, however, also needed in diverse mechanical engineering applications.

The holder 1 has a pillar element 3 as a central component, which has a cylindrical shape, wherein in the present case the axial direction a extends vertically. The pillar element 3 is attached to a retaining plate 11, which can be part of a mechanical engineering system.

A plurality of—in the present case two—retaining elements 5, 6 are disposed on the pillar element 3. They are disposed on the circumferential surface 4 of the pillar element 3 such that they extend away from the pillar element 3 with their main direction of extension in radial direction r.

The two retaining elements 5, 6 have recesses 9 and 10 on their undersides 7 and 8, respectively, which are embodied circular-arc-segment-shaped and are thus matched to the circular cross-section shape of the cable 2.

If one follows the course of the retaining elements 5, 6, and in particular of the recesses 9 and 10 for the laying-on of the cable 2, it can be seen that they are located on a spiral-shaped line w, i.e. they follow the course of the cable 2.

Two threading aids 12 and 13 for immobilizing the cable 2 in the bottom region of the holder 1, i.e. on the surface of the retaining plate 11, are disposed diametrically opposite each other on the pillar element 3, which threading aids 12 and 13 are formed very similar to the retaining elements 5, 6. However on their top side 14 they also have recesses analogous to the recesses 9 and 10, which serve for an improved cable guiding. Analogous recesses are also disposed on the underside of the threading aids 12, 13.

The invention is thus based upon a cylindrical or tubular pillar element 3 (i.e. on an element having a cylindrical or tubular basic geometry which has an appropriate diameter), on which radially projecting retaining elements 5, 6 are disposed. The diameter of the pillar element 3 lies in the range of the inner diameter which the spirally-extending cable 2 has in the strain-relieved state. This can specifically mean that the spirally-extending cable 2 has precisely an inner diameter in its strain-relieved state which corresponds to the outer diameter of the pillar element 3. According to a preferred embodiment, the inner diameter of the spirally extending cable 2 in the strain-relieved state can however also have only between 75% and 100% of the outer diameter of the pillar element 3, so that in use according to its specifications the cable 2 lies on the outer circumference of the pillar element 3 with an elastic pretension.

It can accordingly thus be advantageous if the diameter of the pillar element is selected to be slightly larger than the said cable inner diameter. Then after the threading onto the pillar element 3, the cable 2 lies on the pillar element 3 with low elastic radial tension, which promotes the firm holding of the cable.

The retaining elements 5, 6 are disposed along a path which corresponds to the passage of a thread, i.e. along the spiral-shaped path w; the retaining elements 5, 6 thus correspond in this respect to small circumferential portions of a thread or of a worm gear which extends around the pillar element.

The threading aids 12, 13 are located at the height in which the cable 2 is to be immobilized on the housing—or in the present case on the retaining plate 11. The threading aids 12, 13 can also be already disposed on the said spiral-shaped path w, in order to be able to already guide the cable from here already on the spiral-shaped path w via the retaining elements 5, 6.

Depending on the die technology, during injection molding of the pillar element 3 the retaining elements 5, 6 can be injected onto it, or also manufactured as separate parts and then fixed on the pillar element.

Another manufacturing possibility consists of introducing a groove extending in a thread-like manner in the outer circumference of the pillar element 3 during injection of the pillar element 3. Retaining elements 5, 6 are later fixed at desired points of the thread-shaped groove.

If an end side of the cable 2 laid-on around the pillar element 3 is pulled, due to this axial strain it loops more tightly around the pillar element 3, so that an increased friction force is generated, which secures the cable 2 in its position on the holder 1. In the interaction with the retaining elements 5, 6, a reliable fixing of the cable 2 on the holder 1 results, so that a loosening of the cable 2 from the holder is precluded.

While it is generally unnecessary, of course one more cable clamp can be provided for additional securing of the cable

### REFERENCE NUMBER LIST

1 Cable strain relief holder
2 Cable
3 Pillar element
4 Circumferential surface
5 Retaining element
6 Retaining element
7 Underside
8 Underside
9 Recess
10 Recess
11 Retaining plate
12 Threading aid
13 Threading aid
14 Top side
a Axial direction
r Radial direction
w Spiral-shaped line

1. A cable strain relief holder for a spirally extending cable, comprising:
a pillar element extending in an axial direction and having an outer circumferential surface, and
at least two retaining elements disposed extending radially from the outer circumferential surface, wherein the at least two retaining elements are disposed at different axial positions and at different circumferential positions of the pillar element.

2. The cable strain relief holder according to claim 1, wherein the retaining elements extend perpendicular to the axial direction and radially away from the pillar element.

3. The cable strain relief holder according to claim 2, wherein the retaining elements each have an underside configured to abut the cable.

4. The cable strain relief holder according to claim 3, wherein the underside of each of the retaining elements elements has a recess congruent with an outer shape of the cable.

5. The cable strain relief holder according to claim 4, wherein the retaining elements are disposed on the pillar element such that they follow an imaginary spiral-shaped line.

6. The cable strain relief holder according to claim 5, wherein a lower end of the pillar element is connected to a retaining plate.

7. The cable strain relief holder according to claim 6, wherein at least one threading aid is disposed below the retaining elements and extends perpendicular to the axial direction in a direction radially away from the pillar element.

8. The cable strain relief holder according to claim 7, wherein the pillar element, the retaining elements and the threading aid are formed one-piece.

9. The cable strain relief holder according to claim 7, wherein the retaining elements and the threading aid are manufactured as separate parts which are affixed on the pillar element.

10. The cable strain relief holder according to claim 9, wherein it is comprised of plastic.

11. The cable strain relief holder according to claim 1, wherein the retaining elements each have an underside and a recess is defined in the underside that is congruent with an outer shape of the cable.

12. The cable strain relief holder according to claim 11, wherein the recess is circular arc shaped.

13. The cable strain relief holder according to claim 1, wherein the retaining elements are disposed on the pillar element such that they follow an imaginary spiral-shaped line.

14. The cable strain relief holder according to claim 1, wherein a lower end of the pillar element is connected to a retaining plate.

15. The cable strain relief holder according to claim 1, wherein at least one threading aid is disposed below the retaining elements, the threading aid extending perpendicular to the axial direction in a direction radially away from the pillar element.

16. The cable strain relief holder according to claim 1, wherein the pillar element, the retaining elements and the threading aid are integrally formed as one-piece without seams therebetween.

17. The cable strain relief holder according to claim 1, wherein the retaining elements and the threading aid are manufactured as separate parts which are affixed to the pillar element.

18. The cable strain relief holder according to claim 1, wherein it is comprised of plastic.

19. An apparatus comprising:
a pillar element having a central axis and a circular outer circumferential surface,
a first retaining element and a second retaining element, each extending from the circumferential outer surface of the pillar element in a direction perpendicular to the central axis, wherein the first retaining element is offset from the second retaining element along the central axis such that the first and second retaining elements follow an imaginary spiral line and wherein the first retaining element and second retaining element extend in a common plane that includes the central axis, and
a stretchable cable spirally wound around the pillar element with an elastic pretension and abutting circular arc-shaped grooves defined in an underside of each of the first and second retaining elements.

20. The apparatus according to claim 19, further comprising:
a retaining plate disposed at one end of the pillar element, and
at least one threading aid extending from the circumferential outer surface of the pillar element in a direction perpendicular to the central axis, the threading aid being disposed closer to the retaining plate along the central axis than the first retaining element and the second retaining element,
wherein the cable extends between the retaining plate and the at least one threading aid.
